(19) United States
(12) Patent Application Publication
(10) Pub. No.: US 2024/0118423 A1
(43) Pub. Date: Apr. 11, 2024

(54) SPARSE DEPTH SENSING WITH DIGITAL PIXEL SENSOR

(71) Applicant: Meta Platforms Technologies, LLC, Menlo Park, CA (US)

(72) Inventors: Onur Can Akkaya, Los Altos, CA (US); Song Chen, Redmond, WA (US); Xinqiao Liu, Medina, WA (US); Andrew Samuel Berkovich, Sammamish, WA (US); Tsung-Hsun Tsai, Redmond, WA (US); Yi Zheng, Redmond, WA (US); Raffaele Capoccia, Zurich (CH)

(21) Appl. No.: 18/484,762

(22) Filed: Oct. 11, 2023

Related U.S. Application Data
(60) Provisional application No. 63/441,976, filed on Jan. 30, 2023.
(60) Provisional application No. 63/415,194, filed on Oct. 11, 2022.

(51) Int. Cl. G01S 17/894; G01S 7/487; G01S 17/42

(52) U.S. Cl. CPC G01S 17/894; G01S 7/4873; G01S 17/42

(57) ABSTRACT

A projector sequentially generates light pulses to form a sparse grid array. The light pulses reflect off objects in an environment and are reflected towards a sensor array. The sensor array sequentially senses the reflected light pulses across pixels of the sensor array. A depth sensing system calculates depth information of objects in the environment based on the sequential nature of the pulse generation and the pulse sensing. The depth sensing system calculates depth information based on both the positional and temporal information of generated light pulses, and the positional and temporal information of sensed light pulses. The depth sensing system may generate a representation of the environment based on the depth information.

### CROSS-REFERENCE TO RELATED APPLICATIONS

This application claims the benefit of U.S. Provisional Application No. 63/441,976, filed on Jan. 30, 2023, and U.S. Provisional Application No. 63/415,194 filed on Oct. 11, 2022, both of which are incorporated by reference in their entirety.

### FIELD OF THE INVENTION

This disclosure relates generally to artificial reality systems, and more specifically to sensing depth using structured light for artificial reality systems.

### BACKGROUND

There are many methods of estimating depth in an environment. One such method is structured light (SL)-based depth sensing, which is a widely used technique to estimate depth because of its accuracy and simplicity. These systems typically project a known light pattern onto the scene and capture the spatially modulated reflection using an image sensor. Depth can be computed using triangulation once the projector-camera stereo correspondences are identified from the captured images.

SL-based depth sensing has several fundamental limitations. First, ambient light reduces the signal-to-noise-ratio (SNR) of the projected patterns by increasing the photon shot noise and limits the full well capacity available for the laser induced photo-charges. Second, the computational complexity of the technique is quite high. This difficulty is driven by determining the correspondence between generated light patterns and sensed light patterns in complicated scenes in an environment. Addressing both limitations is important because an accurate and reliable technique for depth sensing in high ambient light environments, that maintains a low computational load, is desirable for future augmented reality and/or virtual reality products.

### SUMMARY

A projector sequentially generates light pulses to form a sparse grid array. The light pulses reflect off objects in an environment and are reflected towards a sensor array. The sensor array sequentially senses the reflected light pulses across pixels of the sensor array. A depth sensing system calculates depth information of objects in the environment based on the sequential nature of the pulse generation and the pulse sensing. The depth sensing system calculates depth information based on both the positional and temporal information of generated light pulses, and the positional and temporal information of sensed light pulses. The depth sensing system may generate a representation of the environment based on the depth information.

In some aspects, the techniques described herein relate to a method for sensing depth with a depth sensing system, the method including: generating, using a projector, a plurality of light pulses that form a sparse array grid, each light pulse sequentially generated across a plurality of projection times; sensing, using a sensor, the plurality of light pulses, wherein the sensor is refreshed after sensing light pulses during sensing periods corresponding to the plurality of projection times; for each sensed light pulse of the plurality: calculating depth information for an environment based on a position of the projector, a position of a pixel on the sensor sensing the light pulse, and a sensing time of a plurality of sensing times at which the pixel sensed the light pulse, wherein each sensing time corresponds to a projection time of the plurality at which the light pulse was generated; and generating a representation of the environment based on the depth information.

In some aspects, the techniques described herein relate to a method, further including: responsive to the pixel of the sensor sensing the light pulse, locking the pixel to preserve the projection time information.

In some aspects, the techniques described herein relate to a method, further including: responsive to the pixel of the sensor sensing the light pulse, storing, at the pixel, time information describing a time the light pulse was sensed.

In some aspects, the techniques described herein relate to a method, wherein calculating the depth information includes reading the time information from the pixel.

In some aspects, the techniques described herein relate to a method, further including: reading, from each pixel on the sensor array, information stored in pixel memory; and determining position information by: identifying pixels storing time information and pixels storing default information in pixel memory, determining position information of sensed light pulses using differences between the identified pixels.

In some aspects, the techniques described herein relate to a method, wherein determining the position information based on the differences between identified pixels employs a position of the pixel from which the information was read.

In some aspects, the techniques described herein relate to a method, wherein sensing a light pulse of the plurality of light pulses includes: accessing an ambient illumination value for the sensor; and comparing a measure of the sensed light pulse to the ambient illumination value.

In some aspects, the techniques described herein relate to a computer program product including a non-transitory computer-readable storage medium containing computer program code that, when executed, causes one or more processors to: generate, using a projector, a plurality of light pulses that form a sparse array grid, each light pulse sequentially generated across a plurality of projection times; sense, using a sensor, the plurality of light pulses, wherein the sensor is refreshed after sensing light pulses during sensing periods corresponding to the plurality of projection times; for each sensed light pulse of the plurality: calculate depth information for an environment based on a position of the projector, a position of a pixel on the sensor sensing the light pulse, and a sensing time of a plurality of sensing times at which the pixel sensed the light pulse, wherein each sensing time corresponds to a projection time of the plurality at which the light pulse was generated; and generate a representation of the environment based on the depth information.

In some aspects, the techniques described herein relate to a computer program product, wherein executing the computer program code further causes the one or more processors to: responsive to the pixel of the sensor sensing the light pulse, lock the pixel to preserve the projection time information.

In some aspects, the techniques described herein relate to a computer program product, wherein executing the computer program code further causes the one or more processors to: responsive to the pixel of the sensor sensing the light pulse, storing, at the pixel, time information describing a time the light pulse was sensed.

In some aspects, the techniques described herein relate to a computer program product, wherein calculating the depth information based on the projection time further causes the one or more processors to: read the time information from the pixel.

In some aspects, the techniques described herein relate to a computer program product, wherein executing the computer program code further causes the one or more processors to: read, from each pixel on the sensor array, information stored in pixel memory; and determine position information by: identifying pixels storing time information and pixels storing default information in pixel memory, determining position information of sensed light pulses using differences between the identified pixels.

In some aspects, the techniques described herein relate to a computer program product, wherein determining the position information based on the differences between identified pixels employs a position of the pixel from which the information was read.

In some aspects, the techniques described herein relate to a computer program product, wherein sensing a light pulse of the plurality of light pulses causes the one or more processors to: access a background illumination value for the sensor; and compare a measure of the sensed light pulse to the background illumination value.

In some aspects, the techniques described herein relate to a system including: a projector system configured to sequentially generate light pulses that form a sparse array grid, each light pulse generated across a plurality of projection times; a sensor array configured to sense light pulses during sensor periods corresponding to the plurality of projection times, the sensor array refreshing after sensing light pulses during sensing periods corresponding to the plurality of projection times; one or more processors; and a non-transitory computer readable storage medium including computer program code that, when executed by the one or more processors, causes the one or more processors to: generate, using the projector system, a plurality of light pulses that form the sparse array grid, sensing, using the sensor array, the plurality of light pulses on the sensor array, for each sensed light pulse of the plurality: calculating depth information for an environment based on a position of the projector, a position of a pixel on the sensor array sensing the light pulse, and a sensing time of a plurality of sensing times at which the pixel sensed the light pulse, wherein each sensing time corresponds to a projection time of the plurality at which the light pulse was generated, and generate a representation of the environment based on the depth information.

In some aspects, the techniques described herein relate to a system, wherein executing the computer program code further causes the one or more processors to: responsive to the pixel of the sensor array sensing the light pulse, lock the pixel to preserve the projection time information.

In some aspects, the techniques described herein relate to a system, wherein executing the computer program code further causes the one or more processors to: responsive to the pixel of the sensor array sensing the light pulse, storing, at the pixel, time information describing a time the light pulse was sensed.

In some aspects, the techniques described herein relate to a system, wherein calculating the depth information based on the projection time further causes the one or more processors to: read the time information from the pixel.

In some aspects, the techniques described herein relate to a system, wherein executing the computer program code further causes the one or more processors to: read, from each pixel on the sensor array, information stored in pixel memory; and determine position information by: identifying pixels storing time information and pixels storing default information in pixel memory, determining position information of sensed light pulses using differences between the identified pixels.

In some aspects, the techniques described herein relate to a system, wherein determining the position information based on the differences between identified pixels employs a position of the pixel from which the information was read.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 illustrates a block diagram of a depth sensing system, in accordance with one or more embodiments.

FIG. 3 illustrates an example of using a projector system and a sensor array to determine the depth of objects in an environment surrounding a depth sensing system, in accordance with one or more embodiments.

FIG. 4 illustrates how a depth sensing system determines depth using a sparse grid array generated by a projector system and pulse events recorded by a sensor array, according to an example embodiment, in accordance with one or more embodiments.

FIG. 5 is a flowchart of a method of determining depth information of an environment using a depth sensing system, in accordance with one or more embodiments.

FIG. 6A illustrates a schematic of first example pixel configured for sensing and recording pulse events in the depth sensing system, in accordance with one or more embodiments.

FIG. 6B illustrates a schematic of a second example pixel configured for sensing and recording pulse events in the depth sensing system, in accordance with one or more embodiments.

FIG. 6C illustrates a schematic of a comparator configured for sensing pulse events in the depth sensing system, in accordance with one or more embodiments.

FIG. 6D illustrates a schematic a dual sample and hold circuit usable in a pixel of the depth sensing system, in accordance with one or more embodiments.

FIG. 7A illustrates a first example timing diagram for generating a light pulse and sensing the corresponding pulse event, in accordance with one or more embodiments.

FIG. 7B illustrates a second example interaction diagram for generating a light pulse and sensing the corresponding pulse event, in accordance with one or more embodiments.

FIG. 7C illustrates a third example interaction diagram for generating a light pulse and sensing the corresponding pulse event, in accordance with one or more embodiments.

FIG. 8 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

An “event-based” structured light method and system for determining depth information from an environment surrounding a depth sensing system are described. A projector sequentially generates light pulses from a sparse grid array (rather than simultaneously). The light pulses reflect off objects in an environment and are reflected towards a sensor array. The sensor array sequentially senses the reflected light pulses across pixels of the sensor array. The depth sensing system calculates depth information based on the sequential nature of the pulse generation and pulse sensing. In other words, the depth sensing system calculates depth information based on both the positional and temporal information of generated light pulses, and the positional and temporal information of sensed light pulses.

Several characteristics of the depth sensing system help enable this process. First, the projector is configured to generate a sparse array by sequentially moving light pulses across its projection plane. Second, the sensor array includes pixels configured to both spatially and temporally resolve sensed light pulses, and store information regarding the sensed light pulse on an in-pixel memory. Finally, the sensor array is configured to sequentially sense multiple light pulses from the same array of generated light pulses. To do so, the sensor array refreshes its state between each generated light pulse, and locks pixels that have previously sensed a light pulse such that they will preserve the projection time information.

[[The following paragraph is boilerplate. No need to review]] Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

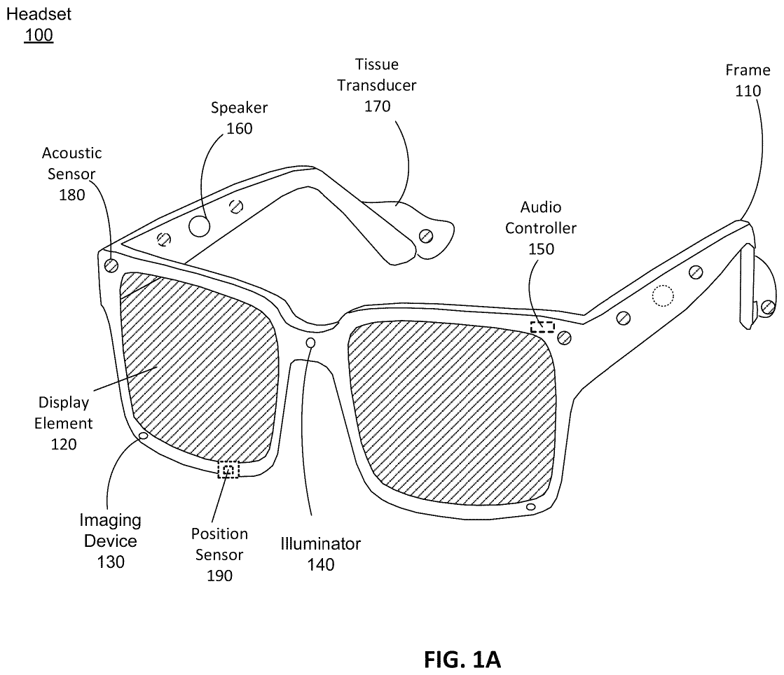

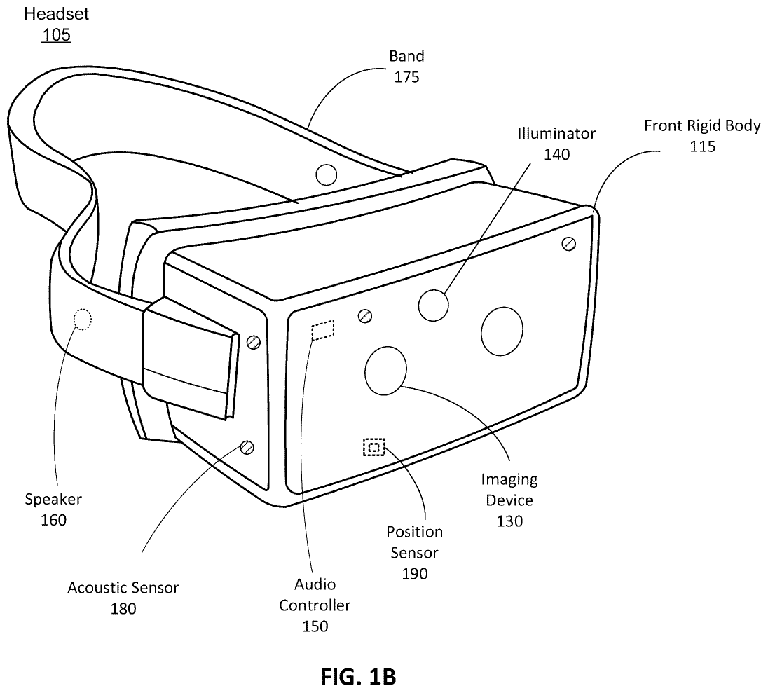

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

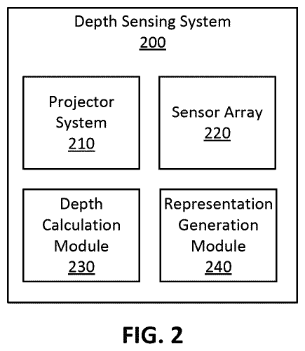

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof. A particular manner of determining depth information based on a sparse grid array is described hereinbelow in regard to FIGS. 2-7C.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

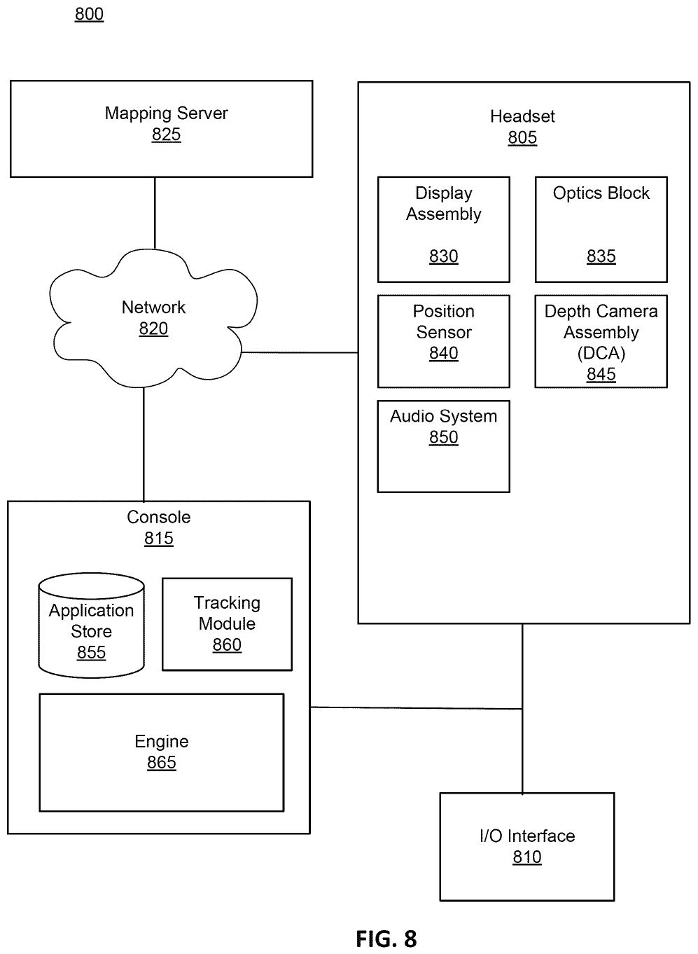

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 8.

FIG. 1B is a perspective view of a headset 105 implemented as a HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to front rigid body 115, or may be configured to be inserted within the ear canal of a user.

FIG. 2 illustrates a block diagram of a depth sensing system 200, in accordance with one or more embodiments. The depth sensing system 200, may also include all or some of the functionality of the DCA described hereinabove. As illustrated, the depth sensing system 200 includes a projector system 210, a sensor array 220, a depth calculation module 230, and a representation generation module 240. In some examples, the depth sensing system 200 may include additional or fewer elements, and/or some of the functionality of the depth sensing system 200 may be attributable to other systems. For instance, the projector system 210 may be a projector system coupled to the headset 100 or may be a projector system 210 remote from the headset 100. Additionally, the various functions and functionality of an element in the depth sensing system 200 may be attributable to other elements of the depth sensing system 200. For example, the depth calculation module 230 may also include the functionality of the representation generation module 240 or vice versa.

The depth sensing system 200 determines depth information describing objects around the depth sensing system 200 in its environment and generates a representation of that environment based on the determined depth information.

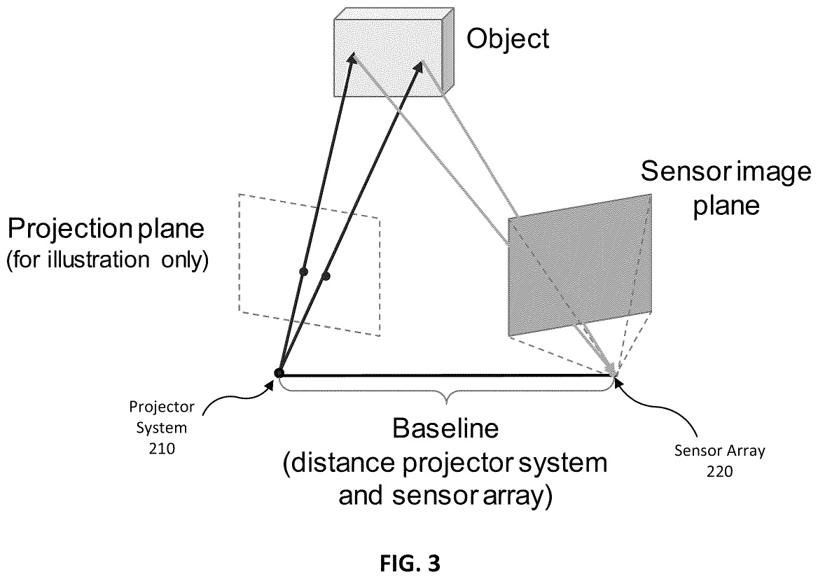

To provide context, FIG. 3 illustrates an example of using a projector system 210 and a sensor array 220 to determine the depth of objects in an environment surrounding a depth sensing system 200, in accordance with one or more embodiments. As shown in FIG. 3, the depth sensing system 200 consists of a laser projector (e.g., projector system 210) a sensor array (e.g., sensor array 220). The projector system 210 projects a laser onto an object in the environment. The object reflects the laser from the object towards the sensor array 220. The projector system 210 and/or the sensor array 220 record a time the laser is projected and a time the reflected laser is incident on the sensor array 220 with high temporal precision (e.g., 1 μs). The depth sensing system 200 determines the distance to the object using one or more of a distance between the center of projection of the projector system 210, the center of projection for the sensor array 220, the position from which the laser is projected by the projector system 210, and the position from which the laser is sensed on the sensor array 220. The depth sensing system 200 may also use temporal information describing the generated and sensed laser pulses to make the determination.

Returning now to FIG. 2, the projector system 210 is a light source configured to project light into the surrounding environment. In an example configuration, the projector system 210 may include, e.g., the illuminator 140, the display element 120, the position sensor 190, etc. of the headset 100. In other examples, the projector system 210 may be a laser system built into the headset 100 or may be a laser system in a standalone device.

The projector system 210 generates light pulses (e.g., laser pulses). In an example configuration, the projector system 210 generates laser pulses that form a sparse grid array. For example, the sparse grid array may be, e.g., a 16 by 16 square grid of laser pulses, but could be other sparse grid arrays. In some instances, the sparse grid array may take another shape (e.g., circular, rectangular, or triangular) and/or may have a greater or lesser density.

The projector system 210 generates light pulses of the sparse grid array across the projection plane of the projector system 210. That is, because the sparse grid array represents a two-dimensional array of light pulses, the projector system 210 is configured to generate light pulses in a manner that reflects that two-dimensional array. Therefore, the projector system 210 is configured to sequentially raster light pulses across the projection plane such that the light pulses, in aggregate, form the sparse grid array.

The projector system 210 generates light pulses at projection times. That is, each light pulse generated by the projector system 210 is generated at a projection time and, therefore, the projector system 210 generates each light pulse in a sparse grid array at a specific projection time. For instance, the projector system 210 generates a first light pulse of a sparse grid array at a first projection time, and generates a second light pulse of a sparse grid array at a second projection time, etc. In this manner, the projector system 210 sequentially generates the light pulses of the sparse grid array for projection into the environment. The depth sensing system 200 may record at what projection time each light pulse is generated (either as an actual time or a position in a sequence), which can be used to identify depth information in the environment.

Additionally, each of the light pulses generated by the projector system 210 has its own characteristics. For instance, each light pulse may have a pulse size (e.g., diameter), a pulse time (e.g., when it is projected), a pulse length, etc. Pulse sizes are on the order of microns, light pulses occur every tens of microseconds, and pulse lengths are on the order of microseconds. Additionally, the projector system 210 generates a sparse grid array that has its own characteristics. For instance, each sparse grid array may have an array timing (describing the pulse times), an array positioning (describing the position of pulses in the sparse grid array), an array ordering (describing in which order pulses are projected), etc.

To provide additional context, in an example configuration, the projector system 210 is a laser scanner based on MEMS micromirrors. The laser scanner may be a resonant device that scans a laser beam at a fixed resonant frequency, or may be a quasi-static device that can point the laser beam to a desired location and maintain its position for a desired period. In either case, the projector system 210 engages the laser source when generating a light pulse of the sparse grid array, and disengages the laser source when transitioning to the next position of sparse grid array. The laser scanner is engaged at each position for some time sufficient for the sensor array 220 to detect a pulse event (relative to the noise and background) as described below. Additionally, the generated light pulses are short enough and small enough to illuminate only a small number of pixels (e.g., a single pixel). Moreover, the time between each laser pulse is longer than the temporal resolution of the sensor array 220 so that every pulse event has a distinct temporal signature (e.g., a timestamp). Additionally, the depth sensing system 200 may be configured to account for systematic errors and temporal jitter in the laser pulses of the projector system 210.

Whatever the configuration, the projector system 210 projects light pulses of the sparse grid array into the environment where they interact with objects positioned therein. The light pulses are incident onto incident areas of various objects and are reflected away from the various objects from the incident areas. Depending on the shape of the various objects, the light may be reflected towards the sensor array 220, or different areas of the senor array 220.

### Sensor Array

The sensor array 220 senses light in the environment. Therefore, the sensor array 220 senses light pulses generated by the projector system 210 and reflected by objects in the environment towards the sensor array 220. For convenience, light pulses generated by the projector system 210 and sensed by the sensor array 220 are referred to as “pulse events.”

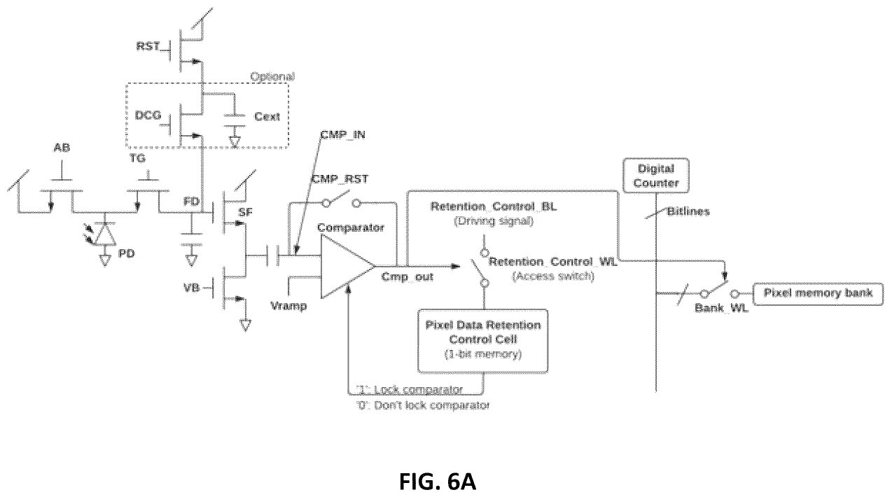

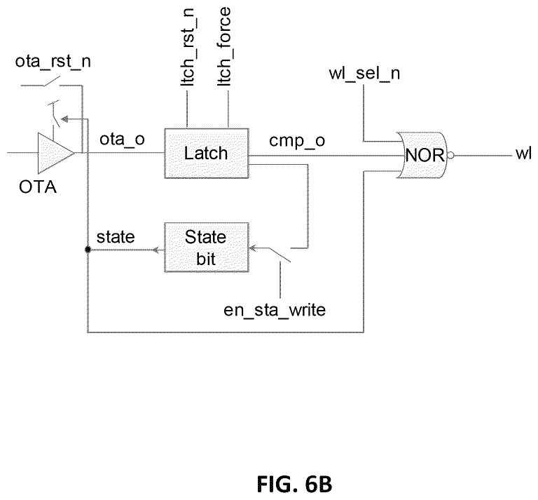

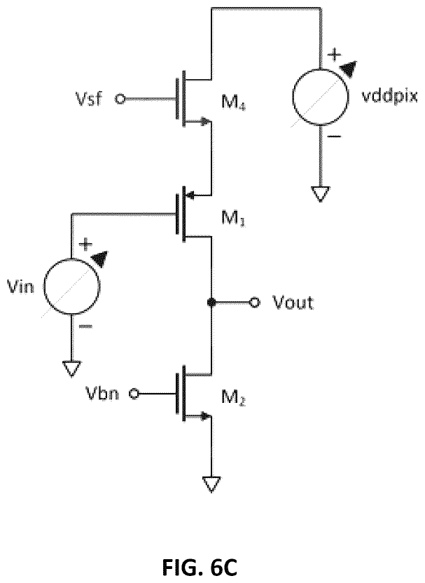

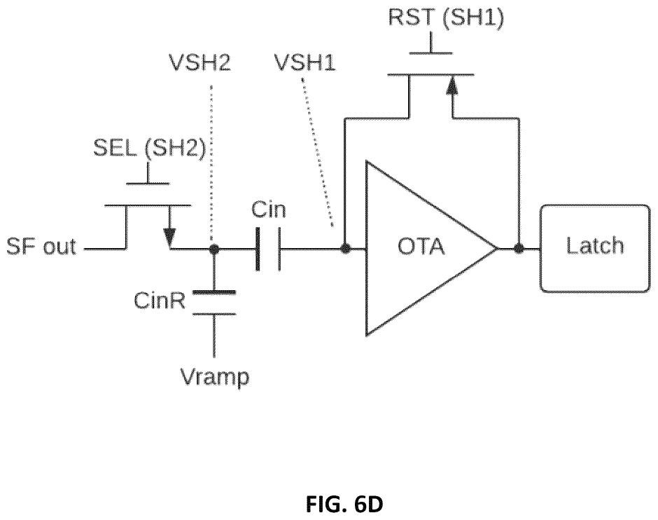

The sensor array 220 includes a two-dimensional array of pixels. The pixels enable the sensor array 220 to resolve pulse events spatially and temporally. Spatial and temporal resolution of pulse events enables the depth sensing system 200 to spatially resolve objects in the environment. Example pixel configurations enabling this functionality are disclosed hereinbelow at FIGS. 6A-6D.

In an example configuration, the sensor array 220 operates in a time-to-saturation mode (“TTS” mode). The TTS mode allows the sensor array 220 to provide timestamps corresponding to pulse events. In this mode, the floating diffusion voltage (V_FD) of a pixel in the sensor array and a reference voltage (V_REF) of the sensor array 220 are continuously compared during the pulse event by an in-pixel comparator. V_FD quantifies the amount of charge accumulating on a pixel during a sensing period, and V_REF quantifies the amount of charge accumulating on a pixel due to background illumination in the sensing period. With this context, when V_FD reaches V_REF the depth sensing system 200 determines that a pulse event occurs. In other words, the depth sensing system 200 determines a pulse event has occurred (e.g., using the in-pixel comparator) when light incident to the pixel is greater than what is expected of background illumination and noise. In some configurations, the sensor array 220 “turns off” a pixel after sensing a pulse event such that it is not allowed to identify another pulse event for some time period (e.g., in the same sparse grid array).

Within the sensor array 220, a pixel sensing the pulse event may store information about the pulse event in in-pixel memory. Information about the pulse event can include both positional and temporal information of the pulse event. Positional information may include the location of the pixel, the location of the sensor array 220, etc. Temporal information may include the time the pulse event was sensed, or a position in a sequence in which the pulse event was sensed (e.g., first, second, third, etc.). In some configurations, the number of bits allocated to the TTS mode (e.g., n=8 bits) determines the XY resolution of the depth map (e.g., 256 pixels). The temporal resolution of the TTS mode is a function of the total exposure time and the number of bits allocated to the TTS mode and can be calculated using their ratio Δt=t_exp/2\hat{ }n.

The sensor array 220 is configured to optimize sensing pulse events relative to background illumination and total noise (e.g., photon shot noise, read noise, etc.) such that, in some cases, only light pulse illumination can trigger a pulse event. In this regard, the depth sensing system 200 may use ambient light and noise levels to set a lower bound on pulse event thresholds. On the other hand, the depth sensing system 200 may set a higher pulse event threshold given the power of pulses generated by the projector system 210. The sensor array 220 may identify background and noise levels before the projector system 210 generates light pulses, and the sensor array 220 may set the appropriate thresholds based on the identified background and noise levels.

Additionally, the sensor array 220 is configured to refresh the pixels in the array multiple times per projection of a sparse grid array. To expand, consider a traditional sensor array operating in time to saturation mode. In this mode, each pixel is continuously accumulating charge while the sensor array 220 is sensing incident light. As such, at some point, each pixel will identify a pulse event because enough background illumination has accumulated on the pixel. Therefore, traditional sensor arrays would identify pulse events across its pixels even when they are not occurring. The sensor array 220 addresses this problem by applying a global pixel reset before each pulse event such that accumulated charge due to ambient light is removed. This operation enables shorter ambient exposure time that is similar to the laser exposure time for every pixel (e.g., 1, 2, 3, 4, 5, 7, 10, etc. microseconds). Note that the global reset does not affect pulse event information stored on in-pixel memory, which allows multiple reset—exposure cycles in a single projection of a sparse grid array.

In other words, the sensor array 220 may be configured to have “sensing periods” for sensing pulse events. A sensing period is a time in which one or more pixels of the sensor array 220 (1) may accumulate sufficient charge in a pixel to trigger a pulse event, (2) may record the temporal and positional information of the sensed pulse event on in-pixel memory, (3) may lock the pixel to prevent it from sensing additional pulse events/preserve the projection time information, and (4) reset the pixel.

The length of a sensing period can be variable depending on the configuration of a pixel. For example, recording the temporal and positional information of a pulse event may take a first amount of time in a first configuration, and may take a second, different amount of time in a second, different configuration. As such, the sensing periods may be tuned based on the configuration of the pixel. Many configurations, however, have a sensing period configured such that only a single pulse event may be detected within the sensing period. In this way, a sensor array 220 reduces the number of pulse events that may be triggered due to background accumulation. Additionally, in some configurations, the sensor array 220 may be configured based on light pulses generated by the projector system 210. For instance, the sensing period may be configured to accommodate light pulses based on the pulse separation and/or pulse lengths of pulses in a sparse grid array.

Additionally, the sensor array 220 may be configured to sense and intensity of each projected light pulse. To do so, when a light pulse dot hits a small group of pixels, the pulse intensity information from the multiple pixels from this small group can be used to calculate a centroid (position) of the light pulse on the image plane of the sensor array by fitting a Gaussian distribution. In other words, if more than one pixel of the sensor array 220 is illuminated within a spatial neighborhood, the sensor array's operation will be similar, but the light pulse power required to trigger a pulse event will be higher. Additionally, the sensor array may be configured such that it is possible that more than one pixel recognizes a pulse event and records similar temporal information. In those cases, the depth sensing system 200 can use the monochrome intensity measurement to find the peak location of the Gaussian light pulse spot and tag that location with the measured temporal information.

Moreover, the sensor array 220 may be used to capture a high-resolution image of the background scene which is co-located with a sparse depth map generated from sensed light pulses. The depth sensing system may use the high-resolution image to guide the densification (improving X, Y resolution) of the sparse depth map with machine learning algorithm. In other words, since the resolution of sparse depth array is limited by the number of bits allocated to the TTS mode, it may be combined with various depth densification methods to upsample the sparse depth map, e.g., using data from an additional monochrome channel or other imaging modalities such as polarization.

The depth calculation module 230 determines depth information of objects in the environment surrounding the depth sensing system 200. To do so, the depth calculation module 230 leverages temporal and spatial information describing the sparse grid array (and its constituent light pulses) generated by the projector system 210, and temporal and spatial information describing pulse events recorded by the sensor array 220.

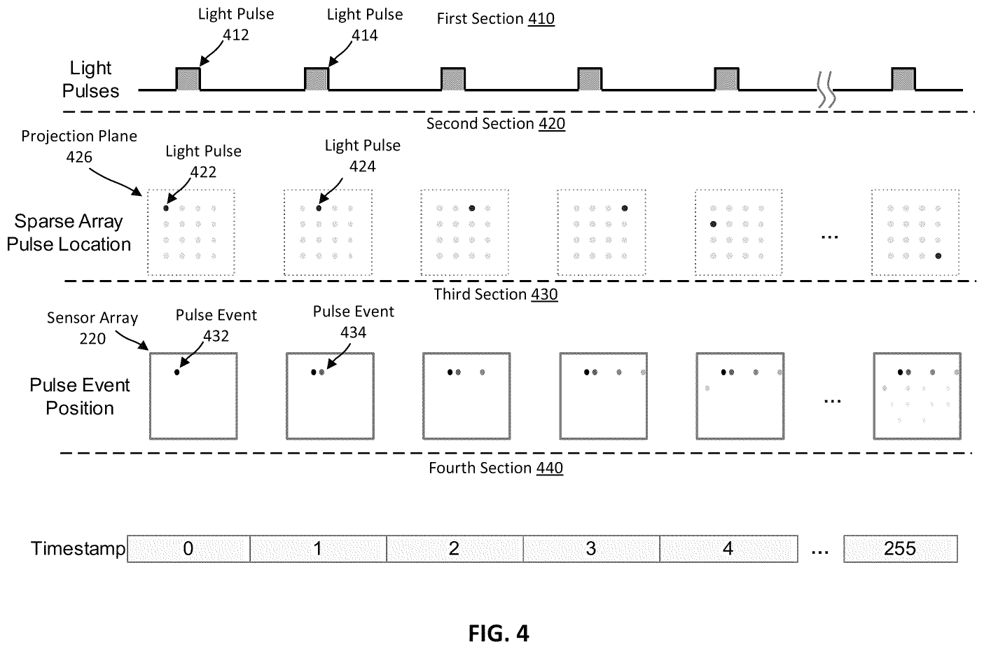

FIG. 4 illustrates how a depth sensing system 200 determines depth information using a sparse grid array generated by a projector system 210 and pulse events recorded by a sensor array 220, in accordance with one or more embodiments.

In FIG. 4, the projector system 210 is configured to generate a 4 by 4 sparse grid array. FIG. 4 includes four sections: a first section 410, a second section 420, a third section 430, and a fourth section 440. Across all four sections time progresses from left to right.

The first section 410 reflects the timing information of light pulses generated by projector system 210. The light pulses are illustrated as a sequential line of squares, which represent the signal sent to the projector system 210 to generate a light pulse. In this illustration, a first light pulse 412 is generated at a first generation time, and a second light pulse 412 is generated at a second generation time, etc.

The second section 420 reflects the positional information of light pulses generated by projector system 210. The light pulses are represented as the 4 by 4 sparse grid array on a projection plane 426 of the projector system 210. The projection plane 426 is represented by a grey square, and the light pulses on the plane are represented by dots on the grey square. In this illustration, the projector system 210 generates the first light pulse 422 (i.e., top left dot) of the sparse grid array at the first generation time, and the second light pulse 424 (i.e., one dot to the right of the top left dot) of the sparse grid array at the second generation time. As time continues, the projector system 210 sequentially generates light pulses of the sparse grid array at their appropriate position on the projection plane 426.

As the projector system 210 generates light pulses from the sparse grid array, they interact with objects in the environment and are reflected towards the sensor array 220. The sensor array 220 senses the light pulses as pulse events as described above.

The third section 430 reflects the position information of pulse events recorded by the sensor array 220. The sensor array is represented by an open square, and pulse events are represented by dots on the open square. Typically, each pulse event corresponds to an individual (or very few) pixels on the sensor array, so each dot may correspond to a pulse event at individual pixels.

In this illustration, the first pulse event 432 is represented by the indicated dot on the sensor array 220. The position information associated with the first pulse event 432 is the position information of the pixel on the sensor array 220 (e.g., x-y location) and the position of the sensor array 220 itself. The first pulse event 432 is triggered when the sensor array 220 senses the first light pulse of the sparse grid array generated by the projector system 210 (e.g., senses light pulse 412/422). The second pulse event 434 occurs at a different pixel on the sensor array 220. The second pulse event 434 is triggered when the sensor array 220 senses the second light pulse of the sparse grid array generated by the projector system 210 (e.g., senses light pulse 414/424). As time continues, the sensor array 220 sequentially senses pulse events corresponding to light pulses of the sparse grid array projected by the projector system 210.

The fourth section 440 reflects the temporal information of pulse events (e.g., 432, 434) recorded by the sensor array 220. The first pulse event 432 is recorded at a first recordation time (e.g., timestamp 0), the second pulse event is recorded at a second recordation time (e.g., timestamp 1), etc. In this illustration, the first pulse event 432 is recorded at the first recordation time in response to the first pulse of the sparse grid array generated at the first generation time by the projector system 210 (e.g., light pulse 412/422), and the second pulse event 434 is recorded at the second recordation time in response to the second pulse of the sparse grid array generated at the second generation time by the projector system 210 (e.g., 414/424). Each recordation time may be an actual time of the sensed pulse event, or a sequential representation of the sensed pulse event.

The depth calculation module 230 determines depth information for the environment using the temporal and positional information of light pulses generated by the projector system 210, and the temporal and positional information of pulse events sensed by the sensor array 220. To illustrate, if the projector system 210 and sensor array 220 were coincident, the difference between the first generation time and the first recordation time may be used to determine the distance between an object and the depth sensing system 200. However, as this is not typically the case, the temporal and positional information of both the light pulses generated by the projector system 210 and the pulse events sensed by the sensor array 220 may be used to triangulate the position of objects in the environment. There are several mathematical models and formulations which may be employed to generate depth and position information based on positional and temporal information from known sources and sensors, any of which may be employed here.

The representation generation module 240 generates representations of the environment based on depth information calculated by the depth calculation module 230.

As a first example, the representation generation module 240 generates a data structure representing objects in the environment from a point of view of the depth sensing system 200. The data structure may be, e.g., a depth image or a set of coordinates representing objects in the environment.

As a second example, the representation generation module 240 generates a data structure representing objects in the environment in a reference frame. For example, as the depth sensing system 200 moves around an environment, it generates depth information representing objects in the environment from different viewpoints. The representation generation module 240 may be configured to create a data structure that represents the position of objects in the environment based on those different viewpoints. In effect, the depth sensing system 200 generates a data structure that spatially locates objects in the environment based on the determined depth information from multiple viewpoints.

In various embodiments, the depth sensing system 200 is included in the headset 100 and the headset 100 may generate the data structures described above. Similarly, in various embodiments, the headset 100 may use the data structure in generating augmented reality or virtual reality content for a user.

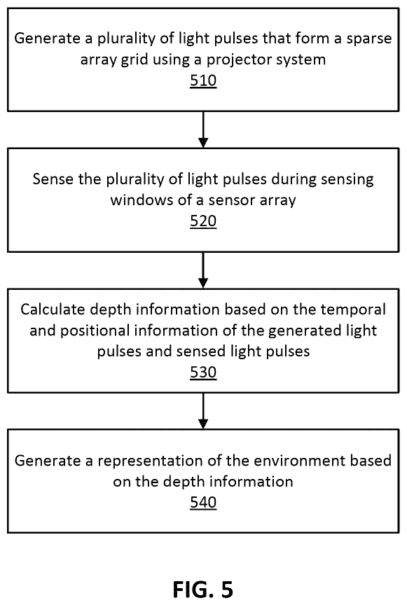

FIG. 5 is a flowchart depicting a method 500 for determining depth information of an environment using a depth sensing system, in accordance with one or more embodiments. The process shown in FIG. 5 may be performed by components of a headset (e.g., headset 100). Other entities may perform some or all of the steps in FIG. 5in other embodiments. Embodiments may include different and/or additional steps, or perform the steps in different orders.

In the illustrated method, a depth sensing system (e.g., depth sensing system 200) senses depth of objects in an environment and generates a representation of the environment based on that information. The depth sensing system 200 may be included in, e.g., a headset 100.

A projector system (e.g., projector system 210) generates 510 a sequential series of light pulses. When viewing the light pulses on a projection plane of the projector system, the light pulses, in aggregate, form a sparse array grid. Each light pulse projected by the projector system in the sparse array grid is projected at a projection time.

The projector system projects the light pulses into the environment, and the light pulses are reflected off objects in the environment. Some portion of the light pulses may be reflected towards a sensor array (e.g., sensor array 220).

A sensor array senses 520 light pulses of the sparse array grid reflected off objects in the environment. Because the sensor array is an array of pixels, the sensor array may sense each individual light pulse at different pixels across the sensor array. When a pixel of the sensor array senses a light pulse, it may record the positional and/or temporal information of the sensed light pulse on an in-pixel memory. The positional information may be a physical position of the pixel on the array. The temporal information may be a time the light pulse was sensed and/or a timestamp indicating a what position in a sequence the light pulsed was sensed (e.g., 1, 2, 3, 4, etc.). The temporal and/or positional information may be associated with (e.g., corresponds to) the generated light pulse triggering the pulse event.

The depth sensing system calculates 530 depth information for the environment using the sensed light pulses. In an embodiment, the depth sensing system calculates the depth information using any of the positional and temporal information of light pulses generated by the projector system, and/or the positional and temporal information of light pulses sensed by the sensor array (e.g., pulse events). The depth sensing system may access the requisite information from the in-pixel memory (e.g., reading the time stamp and pixel location) and/or the projector system.

Positional information of the generated light pulses may include the position of the light pulse in the sparse array grid (e.g., on the projection plane of the projection system), and a position of the projector system. Temporal information of the generated light pulses may include a time which the light pulse was projected, a length of the light pulse, or a position in a sequence when the light pulse was projected. Positional information of the sensed light pulses may include a position of the pixel sensing the light pulse on the sensor array, and a position of the sensor array. Temporal information of the sensed light pulses may include a time which the light pulse was sensed, or a position in a sequence in which the light pulses are sensed. In some cases, the temporal information of the sensed pulse events corresponds to the temporal information of the generated light pulses such that the two may be associated with one another. See, e.g., the timing diagrams described below.

The depth sensing system generates 540 a representation of the environment based on the depth information.

FIG. 6A illustrates a schematic of first example pixel configured for sensing and recording pulse events in the depth sensing system 200, in accordance with one or more embodiments.

The pixel may be included in a two-dimensional array of pixels. Each pixel in the array may include one or more of: (1) one or more photodiodes (PD) for converting light signal to charge signal, (2) a floating diffusion (FD) node for converting charge signal to voltage signal, (3) a transfer gate (TG) for transferring charge from PD to FD, (4) a reset gate (RST) for resetting FD, (5) an anti-blooming (AB) gate for resetting the photodiode, (6) an optional dual-conversion-gain (DCG) transistor and a lateral capacitor (Cext) for switching between high conversion gain and low conversion gain to achieve high dynamic range (HDR), (7) a source follower (SF) and its bias current transistor (VB) for buffering FD voltage signal and driving the comparator, (8) a comparator, an input coupling capacitor, a comparator reset switch (CMP_RST) where the comparator compares SF output voltage with Vramp, (9) a pixel data retention control cell, where the cell's input driving signal (Retention Control BL) is gated by comparator output, the cell's output is feedback to comparator, and the cell decides whether the comparator should be locked or not locked for future operations based the comparator output status from the previous operation, (10) a digital memory (pixel memory bank) for storing projection time information and dot intensity information, where the pixel memory bank's input signal (Bitlines) is gated by comparator output.

Additionally, there may be several components external to the pixel array used to operate the array. The external components may include one or more of: (1) an analog ramping signal generator outside of the pixel array to provide a common driving signal Vramp to all pixels, and (2) a digital counter outside of the pixel array to provide a digital counting signal to drive Bitlines. Additional external components may also be included.

FIG. 6B illustrates a schematic of a second example pixel configured for sensing and recording pulse events in the depth sensing system 200, in accordance with one or more embodiments.

FIG. 6C illustrates a schematic of a comparator configured for sensing pulse events in the depth sensing system 200, in accordance with one or more embodiments.

FIG. 6D illustrates a schematic a dual sample and hold circuit usable in a pixel of the depth sensing system 200, in accordance with one or more embodiments.

As described above, the sensor array and its pixels may be configured such that it senses incident light based on the generation of laser pulses. In other words, the sensor array 220 may be configured with sensing periods based on the light pulses generated by the projector system 210. The following figures illustrate timing diagrams illustrating the interplay of various elements of the depth sensing system 200 within sensing periods. In some example embodiments, the labels of the timing diagrams correspond to components of the pixel of FIG. 6A.

In general, the sensor array and its pixels are configured to operate in the following manner, referring to the elements of the pixel illustrated in FIG. 6A: (1) the pixels in the array are configured to operate simultaneously and periodically (e.g., using a global shutter), (2) every photodiode in pixels in the array is periodically reset between temporally adjacent laser pulses, (3) a comparator in each pixel compares the pixel's source follower (SF) output voltage with a threshold voltage at the end of each laser pulse, and if the source follower (SF) output exceeds the threshold voltage, it means the pixel is hit by a laser pulse, and the pixel's comparator will be locked by the pixel data retention control cell, (4) the digital counter's output increments (or decrements) after each laser pulse as a unique representation of the projection time for each laser pulse and the digital counter writes its output value into each pixel's memory bank (as described above, a pixel's memory bank stops updating its value when its comparator is flipped and locked).

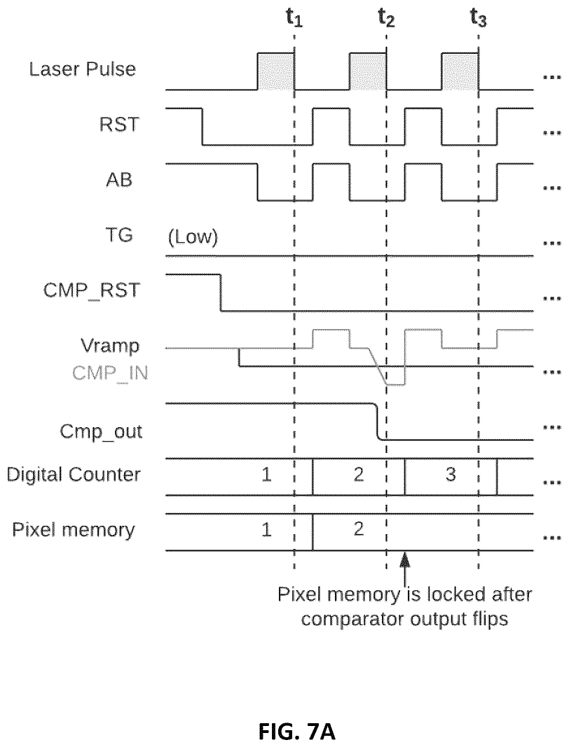

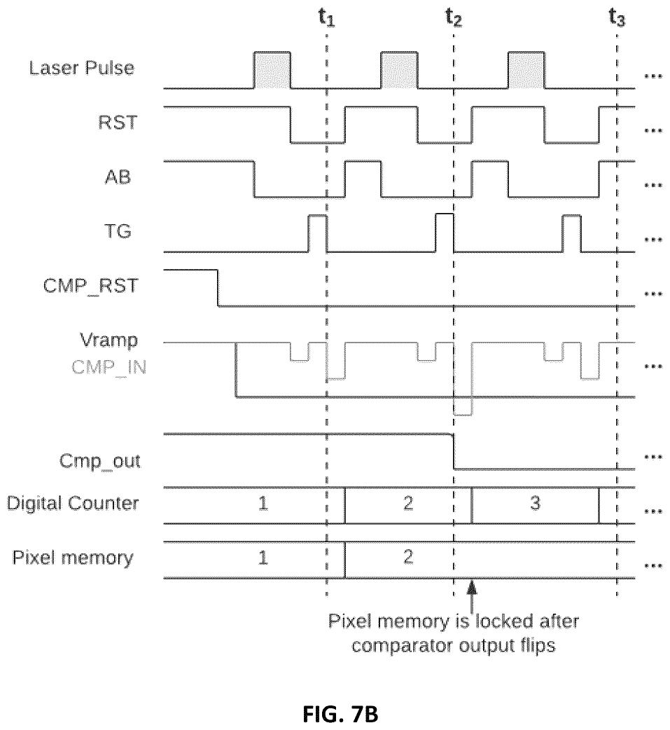

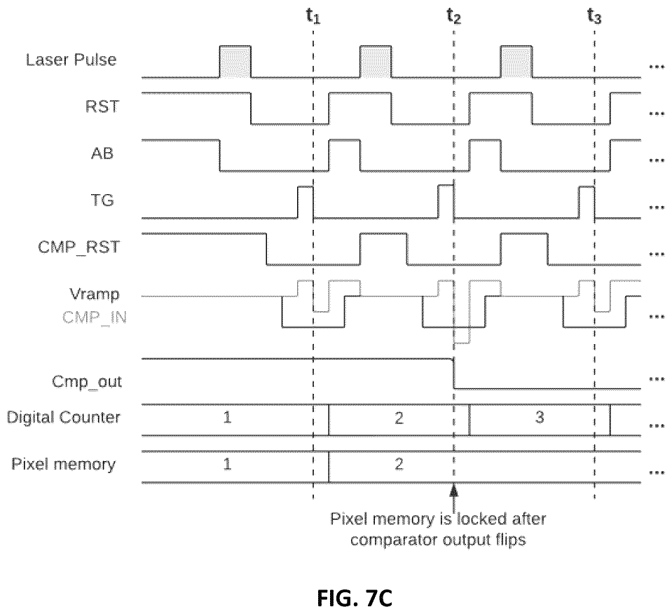

FIG. 7A illustrates a first example timing diagram for generating a light pulse and sensing the corresponding pulse event, in accordance with one or more embodiments. The timing diagram reflects various signals in a pixel (e.g., a pixel of FIG. 6A) using the general method described above. In this example, a light pulse need be strong enough to generate an amount of charge larger than PD FWC to trigger overflow to FD. In other words, the net threshold in charge domain need be larger than PD FWC (i.e., trigger a pulse event).

FIG. 7B illustrates a second example interaction diagram for generating a light pulse and sensing the corresponding pulse event, in accordance with one or more embodiments. The timing diagram in FIG. 7B may be implemented if a threshold smaller than PD FWC is preferred (to trigger a pulse event). There are several differences between the timing diagram of FIGS. 7A and 7B which may cause changes in the general method described above. For instance, in step (2) the charge in every photodiode (PD) is periodically transferred to FD right after each laser pulse; in step (3) the comparator in each pixel compares the pixel's source follower (SF) output voltage change (rather than just output voltage) with a delta threshold (rather than threshold) voltage at the end of each laser pulse, and if the source follower (SF) output change (rather than output) exceeds the delta threshold (rather than threshold) voltage, it means the pixel is hit by a laser pulse, the pixel's comparator will be locked by the pixel data retention control cell.

Additionally, as shown in FIG. 7B, TG will be turned on at the end of each laser pulse to transfer the charge in PD to FD. The transferred charge will be compared to the threshold to determine whether the comparator will be flipped. Since FD is no longer used for store overflow charge, RST pulse can be extended before TG is turned on, which helps reduce FD dark current's impact on threshold variation.

FIG. 7C illustrates a third example interaction diagram for generating a light pulse and sensing the corresponding pulse event, in accordance with one or more embodiments. The timing diagram of FIG. 7C increases the robustness of the methods and systems described herein. There are several differences between the timing diagram of FIGS. 7B and 7C which may cause changes in the general method described in FIG. 7B. In particular, in step (3) the comparator in each pixel is periodically reset before each charge transfer (rather than not including a reset) from PD to FD and compares the pixel's source follower (SF) output voltage change with a delta threshold voltage at the end of each laser pulse, and if the source follower (SF) output change exceeds the delta threshold voltage, it means the pixel is hit by a laser pulse, the pixel's comparator will be locked by the pixel data retention control cell.

Additionally, as shown in FIG. 7C, the comparator is also periodically reset before comparing the signal and the threshold after each laser pulse. Vramp signal is periodically changed to achieve comparator reset. There are several benefits to the timing diagram of FIG. 7C. First, it reduces threshold drift due to comparator input cap leakage, and, second, it reduces kTC noise due to RST pulse because the pixel is effectively running in correlated double sampling mode. Additionally, because this timing diagram includes more pixel operations between the adjacent laser pulses, the minimum gap between laser pulses may be limited which will impact overall scanning speed.

FIG. 8 is a system 800 that includes a headset 805, in accordance with one or more embodiments. In some embodiments, the headset 805 may be the headset 100 of FIG. 1A or the headset 105 of FIG. 1B. The system 800 may operate in an artificial reality environment (e.g., a virtual reality environment, an augmented reality environment, a mixed reality environment, or some combination thereof). The system 800 shown by FIG. 8 includes the headset 805, an input/output (I/O) interface 810 that is coupled to a console 815, the network 820, and the mapping server 825. While FIG. 8 shows an example system 800 including one headset 805 and one I/O interface 810, in other embodiments any number of these components may be included in the system 800. For example, there may be multiple headsets each having an associated I/O interface 810, with each headset and I/O interface 810 communicating with the console 815. In alternative configurations, different and/or additional components may be included in the system 800. Additionally, functionality described in conjunction with one or more of the components shown in FIG. 8 may be distributed among the components in a different manner than described in conjunction with FIG. 8 in some embodiments. For example, some or all of the functionality of the console 815 may be provided by the headset 805.

The headset 805 includes the display assembly 830, an optics block 835, one or more position sensors 840, and the DCA 845. Some embodiments of headset 805 have different components than those described in conjunction with FIG. 8. Additionally, the functionality provided by various components described in conjunction with FIG. 8 may be differently distributed among the components of the headset 805 in other embodiments, or be captured in separate assemblies remote from the headset 805.

The display assembly 830 displays content to the user in accordance with data received from the console 815. The display assembly 830 displays the content using one or more display elements (e.g., the display elements 120). A display element may be, e.g., an electronic display. In various embodiments, the display assembly 830 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 835.

The optics block 835 may magnify image light received from the electronic display, corrects optical errors associated with the image light, and presents the corrected image light to one or both eyeboxes of the headset 805. In various embodiments, the optics block 835 includes one or more optical elements. Example optical elements included in the optics block 835 include: an aperture, a Fresnel lens, a convex lens, a concave lens, a filter, a reflecting surface, or any other suitable optical element that affects image light. Moreover, the optics block 835 may include combinations of different optical elements. In some embodiments, one or more of the optical elements in the optics block 835 may have one or more coatings, such as partially reflective or anti-reflective coatings.

Magnification and focusing of the image light by the optics block 835 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 835 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 835 corrects the distortion when it receives image light from the electronic display generated based on the content.

The position sensor 840 is an electronic device that generates data indicating a position of the headset 805. The position sensor 840 generates one or more measurement signals in response to motion of the headset 805. The position sensor 190 is an embodiment of the position sensor 840. Examples of a position sensor 840 include: one or more IMUs, one or more accelerometers, one or more gyroscopes, one or more magnetometers, another suitable type of sensor that detects motion, or some combination thereof. The position sensor 840 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 805 from the sampled data. For example, the IMU integrates the measurement signals received from the accelerometers over time to estimate a velocity vector and integrates the velocity vector over time to determine an estimated position of a reference point on the headset 805. The reference point is a point that may be used to describe the position of the headset 805. While the reference point may generally be defined as a point in space, however, in practice the reference point is defined as a point within the headset 805.

The DCA 845 generates depth information for a portion of the local area. The DCA includes one or more imaging devices and a DCA controller. The DCA 845 may also include an illuminator. Operation and structure of the DCA 845 is described above with regard to FIG. 1A.

The audio system 850 provides audio content to a user of the headset 805. The audio system 850 is substantially the same as the audio system 200 describe above. The audio system 850 may comprise one or acoustic sensors, one or more transducers, and an audio controller. The audio system 850 may provide spatialized audio content to the user. In some embodiments, the audio system 850 may request acoustic parameters from the mapping server 825 over the network 820. The acoustic parameters describe one or more acoustic properties (e.g., room impulse response, a reverberation time, a reverberation level, etc.) of the local area. The audio system 850 may provide information describing at least a portion of the local area from e.g., the DCA 845 and/or location information for the headset 805 from the position sensor 840. The audio system 850 may generate one or more sound filters using one or more of the acoustic parameters received from the mapping server 825, and use the sound filters to provide audio content to the user.

The I/O interface 810 is a device that allows a user to send action requests and receive responses from the console 815. An action request is a request to perform a particular action. For example, an action request may be an instruction to start or end capture of image or video data, or an instruction to perform a particular action within an application. The I/O interface 810 may include one or more input devices. Example input devices include: a keyboard, a mouse, a game controller, or any other suitable device for receiving action requests and communicating the action requests to the console 815. An action request received by the I/O interface 810 is communicated to the console 815, which performs an action corresponding to the action request. In some embodiments, the I/O interface 810 includes an IMU that captures calibration data indicating an estimated position of the I/O interface 810 relative to an initial position of the I/O interface 810. In some embodiments, the I/O interface 810 may provide haptic feedback to the user in accordance with instructions received from the console 815. For example, haptic feedback is provided when an action request is received, or the console 815 communicates instructions to the I/O interface 810 causing the I/O interface 810 to generate haptic feedback when the console 815 performs an action.

The console 815 provides content to the headset 805 for processing in accordance with information received from one or more of: the DCA 845, the headset 805, and the I/O interface 810. In the example shown in FIG. 8, the console 815 includes an application store 855, a tracking module 860, and an engine 865. Some embodiments of the console 815 have different modules or components than those described in conjunction with FIG. 8. Similarly, the functions further described below may be distributed among components of the console 815 in a different manner than described in conjunction with FIG. 8. In some embodiments, the functionality discussed herein with respect to the console 815 may be implemented in the headset 805, or a remote system.

The application store 855 stores one or more applications for execution by the console 815. An application is a group of instructions, that when executed by a processor, generates content for presentation to the user. Content generated by an application may be in response to inputs received from the user via movement of the headset 805 or the I/O interface 810. Examples of applications include: gaming applications, conferencing applications, video playback applications, or other suitable applications.

The tracking module 860 tracks movements of the headset 805 or of the I/O interface 810 using information from the DCA 845, the one or more position sensors 840, or some combination thereof. For example, the tracking module 860 determines a position of a reference point of the headset 805 in a mapping of a local area based on information from the headset 805. The tracking module 860 may also determine positions of an object or virtual object. Additionally, in some embodiments, the tracking module 860 may use portions of data indicating a position of the headset 805 from the position sensor 840 as well as representations of the local area from the DCA 845 to predict a future location of the headset 805. The tracking module 860 provides the estimated or predicted future position of the headset 805 or the I/O interface 810 to the engine 865.

The engine 865 executes applications and receives position information, acceleration information, velocity information, predicted future positions, or some combination thereof, of the headset 805 from the tracking module 860. Based on the received information, the engine 865 determines content to provide to the headset 805 for presentation to the user. For example, if the received information indicates that the user has looked to the left, the engine 865 generates content for the headset 805 that mirrors the user's movement in a virtual local area or in a local area augmenting the local area with additional content. Additionally, the engine 865 performs an action within an application executing on the console 815 in response to an action request received from the I/O interface 810 and provides feedback to the user that the action was performed. The provided feedback may be visual or audible feedback via the headset 805 or haptic feedback via the I/O interface 810.

The network 820 couples the headset 805 and/or the console 815 to the mapping server 825. The network 820 may include any combination of local area and/or wide area networks using both wireless and/or wired communication systems. For example, the network 820 may include the Internet, as well as mobile telephone networks. In one embodiment, the network 820 uses standard communications technologies and/or protocols. Hence, the network 820 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 820 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 820 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 825 may include a database that stores a virtual model describing a plurality of spaces, wherein one location in the virtual model corresponds to a current configuration of a local area of the headset 805. The mapping server 825 receives, from the headset 805 via the network 820, information describing at least a portion of the local area and/or location information for the local area. The user may adjust privacy settings to allow or prevent the headset 805 from transmitting information to the mapping server 825. The mapping server 825 determines, based on the received information and/or location information, a location in the virtual model that is associated with the local area of the headset 805. The mapping server 825 determines (e.g., retrieves) one or more acoustic parameters associated with the local area, based in part on the determined location in the virtual model and any acoustic parameters associated with the determined location. The mapping server 825 may transmit the location of the local area and any values of acoustic parameters associated with the local area to the headset 805.

One or more components of system 800 may contain a privacy module that stores one or more privacy settings for user data elements. The user data elements describe the user or the headset 805. For example, the user data elements may describe a physical characteristic of the user, an action performed by the user, a location of the user of the headset 805, a location of the headset 805, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 800 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method for sensing depth with a depth sensing system, the method comprising:
generating, using a projector, a plurality of light pulses that form a sparse array grid, each light pulse sequentially generated across a plurality of projection times;
sensing, using a sensor, the plurality of light pulses, wherein the sensor is refreshed after sensing light pulses during sensing periods corresponding to the plurality of projection times;
for each sensed light pulse of the plurality:
calculating depth information for an environment based on a position of the projector, a position of a pixel on the sensor sensing the light pulse, and a sensing time of a plurality of sensing times at which the pixel sensed the light pulse, wherein each sensing time corresponds to a projection time of the plurality at which the light pulse was generated; and
generating a representation of the environment based on the depth information.

2. The method of claim 1, further comprising:
responsive to the pixel of the sensor sensing the light pulse, locking the pixel to preserve the projection time information.

3. The method of claim 1, further comprising:
responsive to the pixel of the sensor sensing the light pulse, storing, at the pixel, time information describing a time the light pulse was sensed.

4. The method of claim 3, wherein calculating the depth information comprises reading the time information from the pixel.

5. The method of claim 1, further comprising:
reading, from each pixel on the sensor array, information stored in pixel memory; and
determining position information by:
identifying pixels storing time information and pixels storing default information in pixel memory,
determining position information of sensed light pulses using differences between the identified pixels.

6. The method of claim 5, wherein determining the position information based on the differences between identified pixels employs a position of the pixel from which the information was read.

7. The method of claim 1, wherein sensing a light pulse of the plurality of light pulses comprises:
accessing an ambient illumination value for the sensor; and
comparing a measure of the sensed light pulse to the ambient illumination value.

8. A computer program product comprising a non-transitory computer-readable storage medium containing computer program code that, when executed, causes one or more processors to:
generate, using a projector, a plurality of light pulses that form a sparse array grid, each light pulse sequentially generated across a plurality of projection times;
sense, using a sensor, the plurality of light pulses, wherein the sensor is refreshed after sensing light pulses during sensing periods corresponding to the plurality of projection times;
for each sensed light pulse of the plurality:
calculate depth information for an environment based on a position of the projector, a position of a pixel on the sensor sensing the light pulse, and a sensing time of a plurality of sensing times at which the pixel sensed the light pulse, wherein each sensing time corresponds to a projection time of the plurality at which the light pulse was generated; and
generate a representation of the environment based on the depth information.

9. The computer program product of claim 8, wherein executing the computer program code further causes the one or more processors to:
responsive to the pixel of the sensor sensing the light pulse, lock the pixel to preserve the projection time information.

10. The computer program product of claim 9, wherein executing the computer program code further causes the one or more processors to:
responsive to the pixel of the sensor sensing the light pulse, storing, at the pixel, time information describing a time the light pulse was sensed.

11. The computer program product of claim 10, wherein calculating the depth information based on the projection time further causes the one or more processors to:
read the time information from the pixel.

12. The computer program product of claim 8, wherein executing the computer program code further causes the one or more processors to:
read, from each pixel on the sensor array, information stored in pixel memory; and
determine position information by:
identifying pixels storing time information and pixels storing default information in pixel memory,
determining position information of sensed light pulses using differences between the identified pixels.

13. The computer program product of claim 12, wherein determining the position information based on the differences between identified pixels employs a position of the pixel from which the information was read.

14. The computer program product of claim 8, wherein sensing a light pulse of the plurality of light pulses causes the one or more processors to:
access a background illumination value for the sensor; and
compare a measure of the sensed light pulse to the background illumination value.

15. A system comprising:
a projector system configured to sequentially generate light pulses that form a sparse array grid, each light pulse generated across a plurality of projection times;
a sensor array configured to sense light pulses during sensor periods corresponding to the plurality of projection times, the sensor array refreshing after sensing light pulses during sensing periods corresponding to the plurality of projection times;
one or more processors; and
a non-transitory computer readable storage medium comprising computer program code that, when executed by the one or more processors, causes the one or more processors to:
generate, using the projector system, a plurality of light pulses that form the sparse array grid,
sensing, using the sensor array, the plurality of light pulses on the sensor array,
for each sensed light pulse of the plurality:
calculating depth information for an environment based on a position of the projector, a position of a pixel on the sensor array sensing the light pulse, and a sensing time of a plurality of sensing times at which the pixel sensed the light pulse, wherein each sensing time corresponds to a projection time of the plurality at which the light pulse was generated, and
generate a representation of the environment based on the depth information.

16. The system of claim 15, wherein executing the computer program code further causes the one or more processors to:
responsive to the pixel of the sensor array sensing the light pulse, lock the pixel to preserve the projection time information.

17. The system of claim 16, wherein executing the computer program code further causes the one or more processors to:
responsive to the pixel of the sensor array sensing the light pulse, storing, at the pixel, time information describing a time the light pulse was sensed.

18. The system of claim 15, wherein calculating the depth information based on the projection time further causes the one or more processors to:
read the time information from the pixel.

19. The system of claim 18, wherein executing the computer program code further causes the one or more processors to:
read, from each pixel on the sensor array, information stored in pixel memory; and
determine position information by:
identifying pixels storing time information and pixels storing default information in pixel memory,
determining position information of sensed light pulses using differences between the identified pixels.

20. The system of claim 19, wherein determining the position information based on the differences between identified pixels employs a position of the pixel from which the information was read.
